(19) United States
(12) Patent Application Publication
(10) Pub. No.: US 2012/0201943 A1
(43) Pub. Date: Aug. 9, 2012

(54) MULTIPURPOSE STERILIZATION AND JUICE EXTRACTION DEVICE

(76) Inventor: Simon Schlör, Darmstadt (DE)

(21) Appl. No.: 13/022,275

(22) Filed: Feb. 7, 2011

(51) Int. Cl. A23L 2/04; A47J 19/02

(52) U.S. Cl. 426/489; 99/484

(57) ABSTRACT

A multipurpose sterilization and juice extraction device. The device includes a pot sized to be received by a base, a basin sized for nesting within the pot, the basin having a funnel in fluid communication with the pot, and a basket sized to nest within the basin having openings for receiving steam passing through the funnel. A lid is provided for fitting atop the basket. The base has a heating element and controls for selectively energizing the heating element. In use, water can be added to the pot for both sterilizing food products partially submerged therein as well as for generating steam for extracting juice from fruit contained within the basket.

### TECHNICAL FIELD

The present invention is directed to a multipurpose sterilization and juice extraction device which can also be employed for cooking. Through the manipulation of key components of the device, a single heating element can be employed to sterilize food products as well as to generate steam for extracting juice from fruit contained therein.

### BACKGROUND OF THE INVENTION

There are a plethora of self contained devices having resistive and conductive heat sources that can be used for cooking and sterilizing food products. Such devices have been taught to include timers and power regulators to enable them to be used for dedicated purposes.

A particularly useful application of such self-contained devices is in the sterilization of preserved products such as fruit-bases jams and the like. It is common fort in-home canning to apply fruit, sugar and other ingredients to jars and similar containers and to heat the containers and their contents to significant temperatures for sterilization. Upon cooling, a vacuum is created within the containers enabling their contents to be stored for extended periods without spoilage. This procedure generally involves heating water to a high enough temperature for sterilization but below its boiling point to prevent cooking the fruit products to be preserved. It has been found appropriate to partially submerge such containers in water from about 75° C. to below 100° C. in carrying out this process.

Unrelated to the types of cooking and sterilization devices described above are those that have been configured uniquely to extract juice from fruit by steam injection. Typical of such devices is that disclosed in U.S. Pat. No. 4,640,186, the disclosure of which is incorporated by reference. Specifically, such devices employ a water source which is heated to at or near its boiling point. Steam thus produced is directed through a funnel configured within a collection container and into a suspended sieve containing fruit. As noted, the '186 patent deals with a steam juice extractor which has a water cup for producing steam, a juice collecting container arranged on the water cup having a steam funnel and a fruit container arranged on the juice collecting container. Sieve openings are provided for discharging juice from the fruit container. The juice extractor is also provided with a juice discharge conduit in the region of the bottom of the juice collecting container and with a cover which closes the fruit container.

For those wishing to cook food, sterilize food products, such as jams and compotes in vessels and extract juice from fruit, multiple cooking devices have been required. As noted above, several of these operations employ not only heating elements, but also water reservoirs and it is a prime object of the present invention to suggest a device which combines these various components while taking advantage of those economies inherent in doing so.

These and other advantages will be more readily apparent when considering the following disclosure and appended claims.

### SUMMARY OF THE INVENTION

A multipurpose sterilization and juice extraction device. The device includes a pot sized to be received by a base, a basin sized for nesting within the pot, the basin having a funnel in fluid communication with the pot and a basket sized to nest within the basin having openings for receiving steam passing through the funnel. A lid is provided for fitting atop the basket. The base has a heating element and controls for selectively energizing the heating element. In use, water can be added to the pot for both sterilizing food products partially submerged therein as well as for generating steam for extracting juice from fruit contained within the basket.

### BRIEF DESCRIPTION OF THE FIGURES

FIG. 1 is an exploded perspective view of the various component parts constituting the present invention.

FIGS. 2A, 2B and 2C are cross sectional views of the present invention depicting its various uses as a universal multipurpose sterilization, juice extraction and cooking device.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

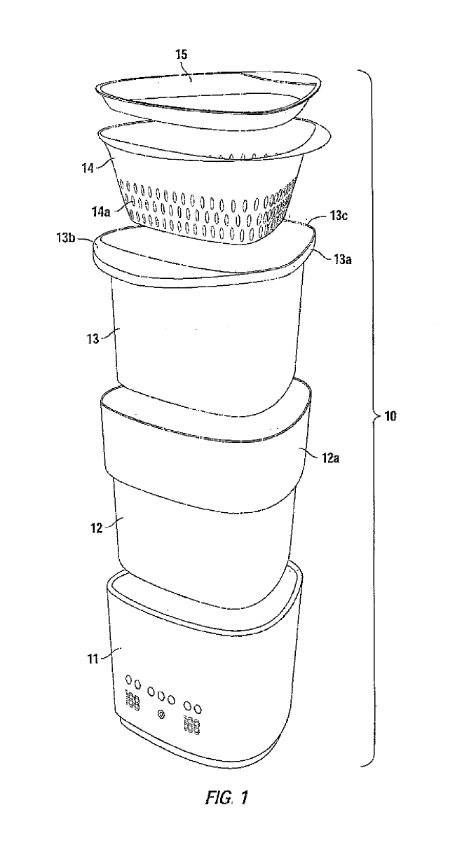

In turning to FIG. 1, multipurpose sterilization and juice extraction device 10 is depicted. This device is composed of a number of self nesting components which are selectively employed depending upon the purpose to which the present device is to be dedicated. In all instances, the present device includes base 11 equipped with a radiant or inductive heat source 21. Heat source 21 can be controllable manually as to both time and temperature and can be provided with an automatic timer and programmable cooking temperature endpoint or range for cooking, sterilization and steaming/juice extraction. Controls of this type are exceedingly well known. For example, reference is made to U.S. Pat. No. 5,567,458 relating to insulated thermal cooking devices including an electric heater, thermal sensor, microprocessor controller and timer, the disclosure of which is incorporated by reference herein. Generally, sterilization is carried out at temperatures between approximately 75° C. and 100° C. Steam is created at approximately 100° C. for juice extraction while heating and cooking foods is highly dependent upon the nature of the food product.

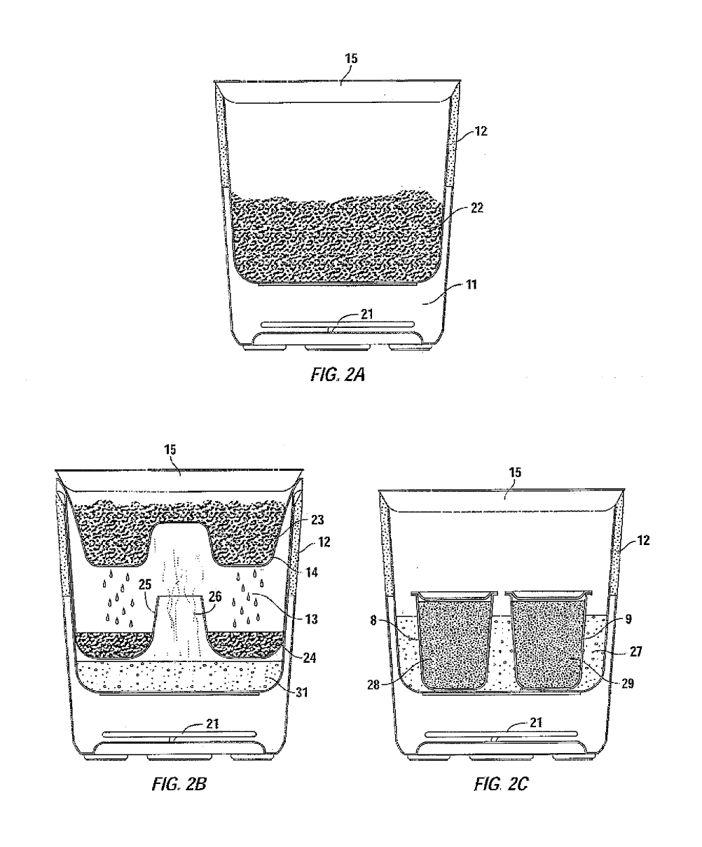

As noted above, a key feature of the present invention is to provide a singular device capable of performing seemingly unrelated functions while employing common components in doing so. For example, base 11 containing heating element 21 and associated controls can be used universally for the multiple functions described herein. Pot 12 is inserted within base 11 which nests within the base up to ridge 12A as shown. Pot 12 is intended to either receive food products for cooking (FIG. 2A) or a body of water (31 of FIGS. 2B and 27 of FIG. 2C). Once water is added to pot 12, it can be employed for multiple functions depending upon the use to which the present invention is to be applied.

If the present invention is intended to simply heat or cook food products, such as jams, soups, stews, pasta, vegetables and the like, a quantity of such food product 22 is simply applied to pot 12 and heating element 21 energized.

Alternatively, in reference to FIG. 2C, pot 12 can be charged with a quantity of water 27 whereupon vessels 8 and 9, containing food products, such as jams, compotes and other products 28 and 29, typically canned by homemakers for long term storage, are partially submerged within water body 27 and heating element 21 engaged. Generally, vessels 8 and 9 are submerged to approximately 75 percent their height while maintaining a temperature of water 27 between approximately 75° C. and 100° C. Lid 15 can reside atop pot 12 to lessen evaporation. Upon sterilization, vessels 8 and 9 are removed from pot 12 whereupon water 27 can remain or replace as needed.

Conversion of the sterilizing device made the subject of FIG. 2C to a juice extraction device is a simple operation. In fact, if one retains water 27 (water 31) in place, one need only nest basin 13 within pot 12 up to ledge 13A whereupon basket 14 is nested within basin 13 and lid 15 placed thereon to complete the subject conversion.

As noted by reference to FIG. 2B, basin 13 is provided with funnel 25 in fluid communication with pot 12 and water 31 contained therein. Funnel 25 narrows the passage of steam 26 created by heating water 31 by energy source 21 and accelerates the passage of steam 26 towards basket 14 containing a suitable quantity of fruit 23. As noted in reference to U.S. Pat. No. 4,640,186, the disclosure of which is incorporated by reference, steam 26 in passing through openings 14A extracts juice from fruit 23 which drips from basket 14 through openings 14A and collected as juice mass 24 within basin 13. Periodically, basin 13 can be emptied of juice 24 by removing basket 14 and lid 15 therefrom and grasping basin 13 by lip 13B. As, ideally, the present device is triangularly shaped, juice 24 is conveniently dispensed over edge 13C into an appropriate collection vessel (not shown).

It is readily apparent that synergies exist between the various parts constituting the present invention unachievable by the prior art. A singular base element having an energy source and controlling electronics can be employed for cooking, sterilizing and juice extraction. A single water charge contained within a pot nested within the base can again be employed for both sterilization and juice extraction. One can readily convert this device to its various uses by simply and appropriately changing the controls imposed upon the energy source while removing or installing subparts such as the above described basket and basin to achieve the sought after results.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

What is claimed is:

1. A multipurpose sterilization and juice extraction device comprising a base, a pot sized to be received by said base, a basin sized for nesting within said pot, said basin having a funnel in fluid communication with said pot, and a basket sized to nest within said basin having openings for receiving steam passing through said funnel and a lid for fitting atop said basket, said base having a heating element for introducing thermal energy to said device.

2. The multipurpose sterilization and juice extraction device of claim 1 wherein said pot is caused to contain water and said heating element is sized to enable said device to heat said water to its boiling point to generate steam thereby.

3. The multipurpose sterilization and juice extraction device of claim 2 wherein upon removable of said basin and basket from said pot, said pot is sized to receive food products in vessels, said vessels being partially submerged within said water.

4. The multipurpose sterilization and juice extraction device of claim 3 wherein said heating element is sized and controlled to raise temperature of said water to at least approximately 75° C. for sterilizing said food products.

5. The multipurpose sterilization and juice extraction device of claim 2 wherein said basket contains fruit which upon exposure to steam passing through said funnel expresses juice.

6. The multipurpose sterilization and juice extraction device of claim 5 wherein said openings in said basket are sized and positioned to facilitate passage of said juice therethrough for collection within in said basin.

7. A multipurpose sterilization and juice extraction device comprising a base, a pot sized to be received by said base, a basin sized for nesting within said pot, said basin having a funnel in fluid communication with said pot, and a basket sized to nest within said basin having openings fat receiving steam passing through said funnel and a lid for fitting atop said basket, said base having a heating element for introducing thermal energy to said device, said basin and basket being selectively removable from said pot whereupon said pot contains water and at least one vessel containing a food product to be sterilized, said heating element being sized and controlled to raise temperature of said water between approximately 75° C. and 100° C. and upon removal of said at least one vessel and upon nesting said basin on said pot and said basket on said basin and fruit within said basket, said heating element being controlled such that water within said pot is brought to boiling whereupon said basket, basin and pot are positioned to direct steam generated within said pot to said fruit and juice emanating from said fruit is collected within said basin.

8. A method of sterilizing food products and extracting juice horn fruit, said method comprising providing a base, a pot sized to be received by said base, a basin sized for nesting within said pot, said basin having a funnel in fluid communication with said pot, and a basket sized to nest within said basin and having openings for receiving steam passing through said funnel and a lid for fitting atop said basket, said base having a heating element for introducing thermal energy to said device wherein said device is converted to one that sterilizes food products by removing said basin and basket from said pot, adding water to said pot and partially submerging vessels containing said fruit products within said water, said water being heated between approximately 75° C. and 100° C. and converting said device to one that extracts juice from fruit by nesting said basin upon said pot and basket containing fruit upon said basin and bringing said water to approximately 100° C. for generating steam directed through said funnel and into said basket whereupon juice is extracted from said fruit and collected within said basin.

9. The method of claim 8 wherein said water, basin and basket are removed from said pot and food products introduced therein for cooking.
